(19) United States
(12) Patent Application Publication
(10) Pub. No.: US 2020/0242819 A1
(43) Pub. Date: Jul. 30, 2020

(54) POLYLINE DRAWING DEVICE

(71) Applicant: Mitsubishi Electric Corporation, Tokyo (JP)

(72) Inventor: Mamoru MIURA, Tokyo (JP)

(73) Assignee: Mitsubishi Electric Corporation, Tokyo (JP)

(21) Appl. No.: 16/852,141

(22) Filed: Apr. 17, 2020

Related U.S. Application Data
(63) Continuation of application No. PCT/JP2017/043655, filed on Dec. 5, 2017.

(51) Int. Cl. G06T 11/20; G06T 7/11

(52) U.S. Cl. CPC G06T 11/203; G06T 2207/10028; G06T 7/11

(57) ABSTRACT

A polyline drawing device includes processing circuitry to extract a target point cloud for drawing a polyline from point cloud data, to perform processes including: setting a local region in the point cloud; obtaining a point being located in a center of mass of points of a point cloud in the local region as a representative point; removing points other than the representative point included in the local region for which the point being located in the center of mass is obtained; setting a circular region whose center is the representative point to a next local region; and obtaining a point being located in a center of mass of points of a point cloud in the next local region as a next representative point; and to draw a polyline by connecting all representative points in turn.

### CROSS REFERENCE TO RELATED APPLICATION

This application is a Continuation of PCT International Application No. PCT/JP2017/043655, filed on Dec. 5, 2017, which is hereby expressly incorporated by reference into the present application.

### TECHNICAL FIELD

The invention relates to a polyline drawing device that approximately represent, by polylines, terrains or graphics which are represented by three-dimensional point cloud data.

### BACKGROUND ART

Three-dimensional point cloud data is useful for grasping and analyzing shapes of objects or structure of space. The three-dimensional point cloud data is a set of three-dimensional point coordinate values [X, Y, Z] in a specific coordinate system (generally, the location of a three-dimensional measuring device serves as the origin). In some three-dimensional measuring devices, the three-dimensional points include the following supplementary information. Namely, the supplementary information includes color information, laser reflection intensity (in a case of a measuring device that irradiates with laser), normal orientation, etc.

When three-dimensional point cloud data is displayed by some kind of display device, by displaying a contour line serving as a guide at a specific height, checking and analyzing tasks are facilitated. For example, when a contour line is displayed at a focused height upon checking three-dimensional point cloud data obtained by measuring a terrain, the terrain can be more efficiently grasped. In some cases, the height at which a contour line is drawn is predetermined, and in other cases, the height is specified by a user each time. For the specification by the user, the height is inputted in a numerical value, or a point at a target height is selected by a click, etc. When the height at which a contour line is drawn is predetermined, a contour line at the determined height is calculated once beforehand. On the other hand, in a case of specification by the user, a contour line needs to be calculated every time depending on the height specified by the user.

At present, three-dimensional point cloud data may be browsed using not only general-purpose computers having abundant computational resources (so-called desktop personal computers and workstations), but also terminals having relatively limited computational resources such as smartphones and tablet computers. Such terminals are easy to carry and are convenient for checking measurement results in real time on a site where three-dimensional measurement is performed. When a shape represented by three-dimensional point cloud data is grasped smoothly using such a terminal having relatively limited computational resources, it is important to draw a smooth contour line at a high speed.

A conventional method of drawing such a contour line is disclosed in Patent Literature 1, for example. In this method, the following processes are performed.

1. A reference location line is set on a location at a height at which a contour line is to be created from point cloud data, an upper location line and a lower location line are set with reference to the reference location line, and two layers, an upper layer and a lower layer, are formed.
2. A straight line that connects two points between point cloud data belonging to the upper layer and point cloud data belonging to the lower layer at the shortest distance is calculated, and a point of intersection of the straight line and the reference location line is calculated. Thus, a plurality of straight lines and a plurality of points of intersection are calculated.
3. The points of intersection obtained at the above-described 2 are connected in turn. In the connection, any of the points of intersection is set as an end point (start point), and the end point of a line is connected, by a straight line, to a point present at the shortest distance from the end point, and this process is repeated. Note, however, that a point that is already connected does not serve as a target, and only a point that is present in a given ranges of angles and distance from an extended line of two points connected last is connected.

### CITATION LIST

### Patent Literatures

Patent Literature 1: JP 2003-317112 A

### SUMMARY OF INVENTION

### Technical Problem

However, the above-described conventional method has the following problems.

(1) Since the amount of computation is relatively large, it takes time to draw and display contour lines.
(2) Depending on the quality of point cloud data, contour lines are jagged, and their visibility decreases.

The above-described problem (1) that the amount of computation is relatively large is caused by the following reason. Specifically, in the technique of Patent Literature 1, after dividing point cloud data into an upper layer and a lower layer, a straight line that connects a point belonging to the upper layer to a point belonging to the lower layer at the shortest distance is calculated. In this process, for one point belonging to either one of the layers, a nearest neighbor search process needs to be performed in the other layer. Furthermore, a process of obtaining a point of intersection of the calculated straight line and a reference location line is also required. Due to these processes, the amount of computation is relatively large.

In addition, the above-described problem (2) that a contour lines are jagged is caused by the following reason. Specifically, in the technique of Patent Literature 1, a contour line is drawn by connecting some points included in inputted point cloud data. When the point cloud data includes points with large measurement errors or noise, by connecting these points, a contour line which is an output is jagged. In addition, even if the aforementioned off-points are not included or even if off-points can be removed by some kind of method, in three-dimensional point cloud data having a complex shape, a contour line is jagged after all.

The invention is made to solve the above problems, and an object of the invention is to provide a polyline drawing device capable of performing a process of providing an approximate representation by a polyline at high speed, and capable of drawing a smooth polyline.

### Solution to Problem

A polyline drawing device according to the invention includes processing circuitry to extract a target point cloud for drawing a polyline; to perform processes including: setting one of local regions in the target point cloud; obtaining a point being located in a center of mass of points of a point cloud in the one of the local regions as one of representative points; removing points other than the one of the representative points included in the one of the local regions for which the point being located in the center of mass is obtained; setting a circular region whose center is the one of the representative points to next one of the local regions; and obtaining a point being located in a center of mass of points of a point cloud in the next one of the local regions as next one of the representative points; and to draw a polyline by connecting all of the representative points obtained by the vertex creating unit in turn.

### Advantageous Effects of Invention

In the polyline drawing device according to the invention, a point being located in a center of mass of points of a point cloud in the one of the local regions is obtained as one of representative points, points other than the next one of the representative points included in the one of the local regions are removed, and a circular region whose center is the one of the representative points is set to next one of the local regions, and a point being located in a center of mass of points of a point cloud in the next one of the local regions is obtained as next one of the representative points. By this, a process of providing an approximate representation by a polyline can be performed at a high speed, and a smooth polyline can be drawn. In addition, the calculation amount can be reduced, and robustness against noise, measurement error, or the like can be achieved.

### BRIEF DESCRIPTION OF DRAWINGS

FIG. 1 is a configuration diagram of a polyline drawing device of a first embodiment of the invention.

FIG. 2 is a hardware configuration diagram of the polyline drawing device of the first embodiment of the invention.

FIG. 3 is a flowchart showing an operation of the polyline drawing device of the first embodiment of the invention.

FIG. 4 is a flowchart showing an operation of a polyline drawing device of a second embodiment of the invention performed when an outline of a cross-section that is obtained when three-dimensional point cloud data is cut on a specific plane which is not parallel to a coordinate plane is rendered.

FIG. 5 is a flowchart showing an operation of the polyline drawing device of the second embodiment of the invention performed when a movement trajectory is rendered from data obtained by plotting, in three-dimensional space, locations of a moving object which are obtained at certain time intervals.

FIG. 6 is a flowchart showing an operation of the polyline drawing device of the second embodiment of the invention performed when only points in a road line region are extracted, and a road line is rendered on the basis of the extracted point cloud.

FIG. 7 is a flowchart showing an operation of a polyline drawing device of a third embodiment of the invention.

FIG. 8 is a flowchart showing an operation of a polyline drawing device of a fourth embodiment of the invention.

### DESCRIPTION OF EMBODIMENTS

To describe the invention in more detail, some embodiments for carrying out the invention will be described below with reference to the accompanying drawings.

### First Embodiment

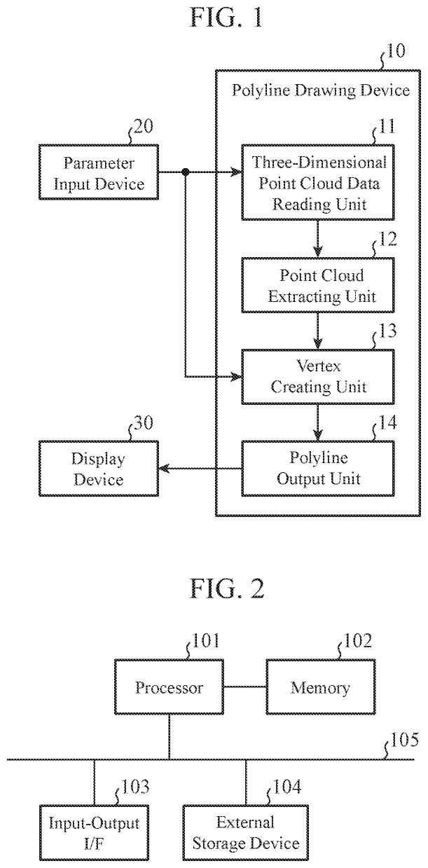

FIG. 1 is a configuration diagram of a polyline drawing device of the present embodiment and peripheral devices thereof.

A polyline drawing device 10 includes a three-dimensional point cloud data reading unit 11, a point cloud extracting unit 12, a vertex creating unit 13, and a polyline output unit 14. The three-dimensional point cloud data reading unit 11 has a function of reading three-dimensional point cloud data, from which a polyline is drawn, into the polyline drawing device 10. The point cloud extracting unit 12 has a function of extracting a target point cloud for drawing a polyline from the three-dimensional point cloud data read by the three-dimensional point cloud data reading unit 11. The vertex creating unit 13 has a function of performing a process of setting one of local regions in the target point cloud, obtaining a point indicating a distribution state of a point cloud in the one of the local regions as one of representative points, setting next one of the local regions using the one of the representative points as a reference, and obtaining a point indicating a distribution state of a point cloud in the next one of the local regions as next one of the representative points, until the target point cloud has no more points that are not included in any of the local regions. The polyline output unit 14 has a function of drawing a polyline by connecting all of the representative points obtained by the vertex creating unit 13 in turn.

A parameter input device 20 which is a peripheral device includes input devices such as a keyboard and a mouse, and is used to input, by a user, parameters such as a height at which a polyline is drawn. In addition, a display device 30 displays data of a polyline, etc., outputted from the polyline output unit 14, and includes, for example, a liquid crystal display.

FIG. 2 is a hardware configuration diagram of the polyline drawing device 10.

The polyline drawing device 10 is implemented using a computer, and includes a processor 101, a memory 102, an input-output interface (input-output I/F) 103, an external storage device 104, and a bus 105. The processor 101 loads programs for the respective functions of the three-dimensional point cloud data reading unit 11 to the polyline output unit 14 into the memory 102 and executes the programs, and thereby forms the three-dimensional point cloud data reading unit 11 to the polyline output unit 14. The memory 102 stores various types of data, and forms a working area of the processor 101. The input-output interface 103 is an interface for exchanging signals with the parameter input device 20 and the display device 30 or signals with other peripheral devices. The external storage device 104 stores the programs for the respective functions of the three-dimensional point cloud data reading unit 11 to the polyline output unit 14, and stores various types of data. The bus 105 is a signal path for performing mutual communication and connection between the processor 101, the input-output interface 103, and the external storage device 104.

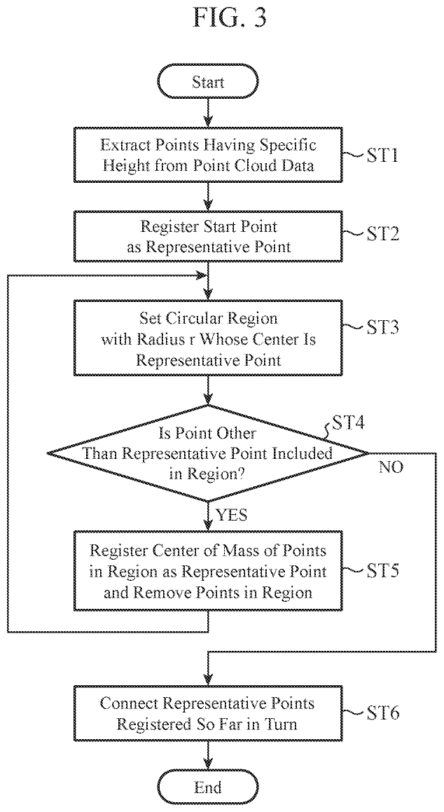

Next, an operation of the polyline drawing device 10 of the first embodiment will be described using a flowchart of FIG. 3. Note that in the first embodiment, as an example of polyline approximation, a contour line is described.

Three-dimensional point cloud data, from which a contour line is drawn, is stored in the external storage device 104, and is read by the three-dimensional point cloud data reading unit 11 and stored in the memory 102. When a parameter such as a height at which a contour line is drawn is inputted by the parameter input device 20, the parameter is stored in the memory 102 through the input-output interface 103. Note that for the input of the parameter, for example, a numerical value is inputted using the keyboard, or a point having a target height is clicked on a screen using the mouse.

The point cloud extracting unit 12 extracts only points having a specific height from the point cloud data read by the three-dimensional point cloud data reading unit 11. For example, the point cloud extracting unit 12 allows the user to specify a height h (m) and an allowed range Δh (m), and obtains a two-dimensional point cloud by extracting only points whose heights (Z-coordinate values) are in a range of (h−Δh, h+Δh) (step ST1). Hereinafter, the two-dimensional point cloud extracted as above is referred to as extracted point cloud. Note that at step ST1, the point cloud data is read from the memory 102, and is processed by the processor 101.

The vertex creating unit 13 calculates vertices of a contour line and order of connecting the vertices from the extracted point cloud extracted by the point cloud extracting unit 12. The processor 101 reads out data from the memory 102 to perform this process. First, a start point is selected and registered as one of representative points (step ST2). Various methods of selecting a start point can be considered, and for example, there are a method of specifying, by the user, coordinate values by some kind of method, and a method of setting a point that is farthest from the center of mass of the extracted point cloud, as a start point. Then, the vertex creating unit 13 sets a circular region with a radius r and whose center is the representative point (step ST3). In addition, if a point other than the representative point is included in the region (step ST4: YES), the center of mass of the points in the circular region is calculated, and the center of mass is registered as a next one of the representative points. Furthermore, all points other than the next representative point that are included in the circular region are removed from the extracted point cloud (step ST5). Thereafter, processing returns to step ST3, and a circular region is set with the next representative point being the center thereof. The processes at step ST3 and ST5 are repeated until regions include no more points other than representative points at step ST4 (step ST4: NO).

The polyline output unit 14 creates a contour line by connecting the representative points calculated by the vertex creating unit 13 in turn (step ST6). In the creation of a contour line, the representative points may be connected by straight lines, or a spline curve that uses the representative points as control points may be drawn. Note that the heights (Z-coordinate values) of all representative points (the vertices of the contour line) are set to be the height h specified by the user. The created contour line is presented to the user by the display device 30.

Although in the above-described example, approximation polyline is assumed to represent a contour line and a point cloud whose heights (Z-coordinate values) are in a predetermined range is extracted, it is not limited to a case of a contour line, and for example, it is also possible that a predetermined range of one-dimensional coordinate value such as X-coordinate value or Y-coordinate value is set to be a target for extracting a point cloud.

In addition, although in the above-described example, for a point indicating a point cloud distribution state of a local region, the center of mass of the local region is obtained as a representative point, it is not limited thereto. For example, medians of respective axial coordinate values of points in a region is calculated, and the point whose coordinate values are the respective medians may be set as a representative point. Other than that, if a point distribution model is known, then it is also possible to apply such a model and set a peak position of the distribution as the coordinate values of a representative point.

Furthermore, although, in the above-described example, a local region is moved in such a manner that a next representative point is the center thereof, the movement of the local region is not necessarily performed in such a manner. For example, a process may be performed in which a straight line is fitted to a point cloud in a local region, and the local region is moved by a certain amount along the straight line.

As described above, the polyline drawing device of the first embodiment includes: a point cloud extracting unit to extract a target point cloud for drawing a polyline; a vertex creating unit to perform processes including: setting one of local regions in the target point cloud, obtaining a point indicating a distribution state of a point cloud in the one of the local regions as one of representative points, setting next one of the local regions using the one of the representative points as a reference, and obtaining a point indicating a distribution state of a point cloud in the next one of the local regions as next one of the representative points; and a polyline output unit to draw a polyline by connecting all of the representative points obtained by the vertex creating unit in turn. Thus, a process of providing an approximate representation by a polyline can be performed at a high speed, and a smooth polyline can be drawn.

In addition, according to the polyline drawing device of the first embodiment, the vertex creating unit performs a process of obtaining the representative point of the local region until the target point cloud has no more points that are not included in any of the local regions, and thus, representative points can be accurately obtained.

In addition, according to the polyline drawing device of the first embodiment, the point cloud extracting unit sets a predetermined range in one dimension of the coordinate and extracts a point cloud in the predetermined range out of a three-dimensional point cloud. Thus, the processing speed can be increased.

In addition, according to the polyline drawing device of the first embodiment, when the vertex creating unit sets the one of the representative points to a center of mass of the one of the local regions, and sets the next one of the local regions, the vertex creating unit sets a circular region with the center of mass being a center of the circular region, and sets the next one of the local regions by removing points in the one of the local regions for which the one of the representative points is set to the center of mass. Therefore, it is possible to increase the processing speed and draw a smooth polyline.

In addition, a polyline drawing method of the first embodiment includes: a point cloud extracting step of extracting, by a point cloud extracting unit, a target point cloud for drawing a polyline; a vertex creating step of setting one of local regions in the target point cloud, obtaining a point indicating a distribution state of a point cloud in the one of the local regions as one of representative points, setting next one of the local regions using the one of the representative points as a reference, and obtaining a point indicating a distribution state of a point cloud in the next one of the local regions as next one of the representative points, the vertex creating step being performed by a vertex creating unit; and a drawing step of drawing, by a polyline output unit, a polyline by connecting all of the representative points obtained at the vertex creating step in turn. Thus, a process of providing an approximate representation by a polyline can be performed at a high speed, and a smooth polyline can be drawn.

### Second Embodiment

The first embodiment aims to draw a contour line having a specific height and being parallel to a coordinate plane (e.g., the XY-plane). Meanwhile, depending on an application, there is a case in which it is required to render a three-dimensional line that does not meet the above-described conditions. For example, there is a case in which an outline of a cross-section that is obtained when three-dimensional point cloud data is cut on a specific plane (not parallel to a coordinate plane) is rendered, or a movement trajectory is rendered from data obtained by plotting, in three-dimensional space, locations of a moving object such as a drone which are obtained at certain time intervals. In addition to them, an application can also be considered in which only points in a road line region are extracted using color information, reflection intensity information, or the like, from three-dimensional point cloud data of an area around a road which is obtained using a mobile mapping system, and a road line is rendered on the basis of the extracted point cloud. Such examples will be described next as a second embodiment.

The configurations of a polyline drawing device of the second embodiment in figures are the same as those of FIGS. 1 and 2, and thus are described using these drawings. The three-dimensional point cloud data reading unit 11 and the polyline output unit 14 of the second embodiment are the same as those of the first embodiment. On the other hand, a point cloud extracting unit 12 has a function of extracting a point cloud which is a target for drawing a polyline in a three-dimensional region. A vertex creating unit 13 is configured to perform the following processes. A local region in a three-dimensional region is set for a point cloud. A point indicating a point cloud distribution state of the local region is obtained as a representative point. A next local region in a three-dimensional region is determined using the obtained representative point as a reference. A point indicating a point cloud distribution state of the next local region in the three-dimensional region is obtained as a next representative point. These processes are performed until the target point cloud has no more points that are not included in any of the local regions. In FIGS. 1 and 2, other configurations are the same as those of the first embodiment, and thus, description thereof is omitted here.

Next, an operation of the polyline drawing device of the second embodiment will be described. First, operation of rendering an outline of a cross-section, when the outline of the cross-section is obtained by cutting three-dimensional point cloud data on a specific plane which is not parallel to a coordinate plane, will be described.

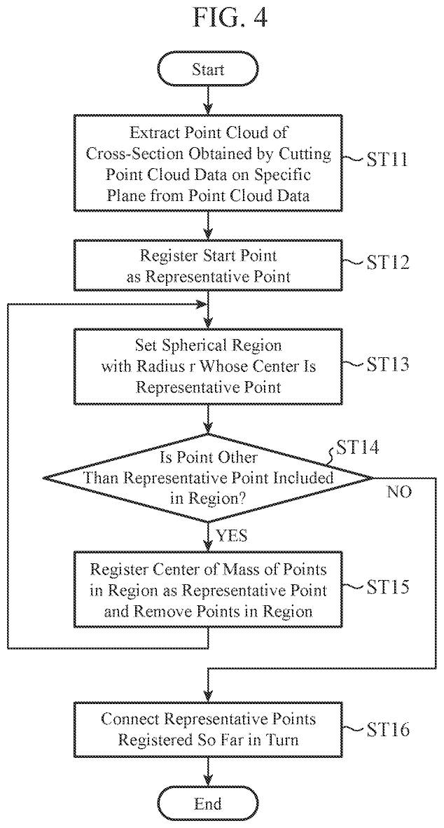

FIG. 4 is a flowchart showing a process of the operation.

The point cloud extracting unit 12 extracts only a point cloud in a certain range from a cross-section from point cloud data read by the three-dimensional point cloud data reading unit 11, the cross-section being obtained by cutting the point cloud data on a specific plane which is not parallel to a coordinate plane (step ST11). Hereinafter, the thus-extracted three-dimensional point cloud is referred to as extracted point cloud.

The vertex creating unit 13 selects a start point from the extracted point cloud extracted by the point cloud extracting unit 12, and registers the start point as a representative point (step ST12). Next, the vertex creating unit 13 sets a spherical region with a radius r whose center is the representative point (step ST13). In addition, if there is a point other than the representative point in the region (step ST14: YES), the center of mass of the point in the spherical region is calculated, the center of mass is registered as a next representative point, and all points included in the spherical region are removed from the extracted point cloud (step ST15). Thereafter, processing returns to step ST13, and a spherical region is set with a next representative point being the center thereof. The processes at step ST13 and ST15 are repeated until regions include no more points other than representative points at step ST14 (step ST14: NO).

The polyline output unit 14 creates an outline by connecting, in turn, the representative points calculated by the vertex creating unit 13 (step ST16). In the creation of an outline, the representative points may be connected by straight lines, or a spline curve that uses the representative points as control points may be drawn. The created outline is presented to the user by the display device 30.

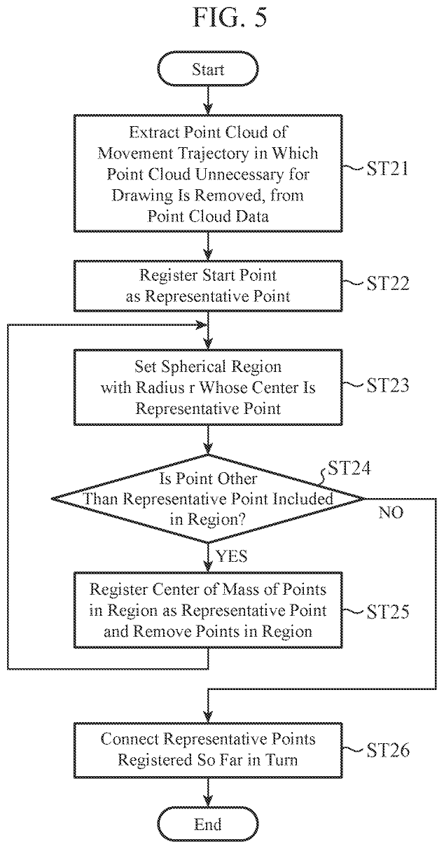

Next, a process performed when a movement trajectory is rendered from data obtained by plotting, in three-dimensional space, locations of a moving object such as a drone which are obtained at certain time intervals will be described using a flowchart of FIG. 5.

The point cloud extracting unit 12 extracts only a point cloud of a movement trajectory in which point clouds unnecessary for drawing are removed, from point cloud data which is read by the three-dimensional point cloud data reading unit 11 (step ST21). For example, point cloud data of a movement trajectory in which points being obviously off-points are removed from the movement trajectory is obtained. Hereinafter, the thus-extracted three-dimensional point cloud is referred to as extracted point cloud.

The vertex creating unit 13 selects a start point from the extracted point cloud extracted by the point cloud extracting unit 12, and registers the start point as a representative point (step ST22). Then, the vertex creating unit 13 sets a spherical region with a radius r whose center is the representative point (step ST23). In addition, if the region includes a point other than the representative point (step ST24: YES), the center of mass of the points in the spherical region is calculated, the center of mass is registered as a next representative point, and all points included in the spherical region are removed from the extracted point cloud (step ST25). Thereafter, processing returns to step ST23, and a spherical region is set with the next representative point being the center thereof. The processes at step ST23 and ST25 are repeated until regions include no more points other than representative points at step ST24 (step ST24: NO).

The polyline output unit 14 creates a movement trajectory by connecting the representative points calculated by the vertex creating unit 13 in turn (step ST26). In the creation of a movement trajectory, the representative points may be connected by straight lines, or a spline curve that uses the representative points as control points may be drawn. The created movement trajectory is presented to the user by the display device 30.

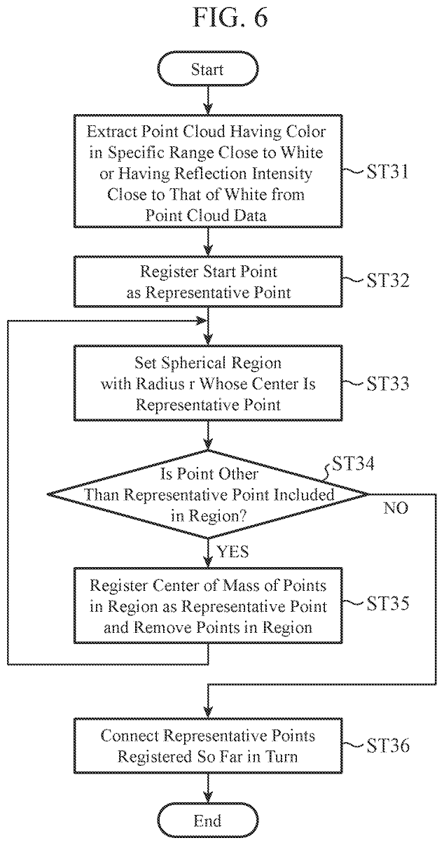

Next, a process performed when only points in a road line region are extracted using color information and reflection intensity information, from three-dimensional point cloud data of an area around a road, and a road line is rendered on the basis of the extracted point cloud will be described using a flowchart of FIG. 6.

The point cloud extracting unit 12 extracts only a point cloud having a color in a specific range close to white or having reflection intensity close to that of white from point cloud data read by the three-dimensional point cloud data reading unit 11 (step ST31). By this, only points in a road line region can be extracted. Hereinafter, the thus-extracted three-dimensional point cloud is referred to as extracted point cloud.

The vertex creating unit 13 selects a start point from the extracted point cloud extracted by the point cloud extracting unit 12, and registers the start point as a representative point (step ST32). Then, the vertex creating unit 13 sets a spherical region with a radius r whose center is the representative point (step ST33). In addition, if the region includes a point other than the representative point (step ST34: YES), the center of mass of the points in the spherical region is calculated, the center of mass is registered as a next representative point, and all points included in the spherical region are removed from the extracted point cloud (step ST35). Thereafter, processing returns to step ST33, and a spherical region is set with the next representative point being the center thereof. The processes at step ST33 and ST35 are repeated until regions include no more points other than representative points at step ST34 (step ST34: NO).

The polyline output unit 14 creates an approximate line of the road line region by connecting the representative points calculated by the vertex creating unit 13 in turn (step ST36). In the creation of an approximate line of the road line region, the representative points may be connected by straight lines, or a spline curve that uses the representative points as control points may be drawn. The created approximate line of the road line region is presented to the user by the display device 30.

As described above, the polyline drawing device of the second embodiment includes a vertex creating unit to perform processes including: setting one of local regions, being a three-dimensional region, in a three-dimensional point cloud, obtaining a point indicating a distribution state of a point cloud in the one of the local regions as one of representative points, setting next one of the local regions, being a three-dimensional region, using the one of the representative points as a reference, and obtaining a point indicating a distribution state of a point cloud in the next one of the local regions as next one of the representative points; and a polyline output unit to draw a polyline by connecting all of the representative points obtained by the vertex creating unit in turn. Thus, a process of providing an approximate representation by a polyline in a three-dimensional region can be performed at a high speed, and a smooth polyline can be drawn.

### Third Embodiment

A third embodiment is an example in which when a vertex creating unit 13 sets a local region using a representative point as a reference, the vertex creating unit 13 changes at least one of a value of a shape and a value of a range of a local region every time repetition is done. The configurations of a polyline drawing device in figures are the same as those of FIGS. 1 and 2, and thus are described using these drawings.

A vertex creating unit 13 of the polyline drawing device of the third embodiment is configured to dynamically adjust the radius r of a circular region. Other configurations are the same as those of the first embodiment, and thus, description thereof is omitted here.

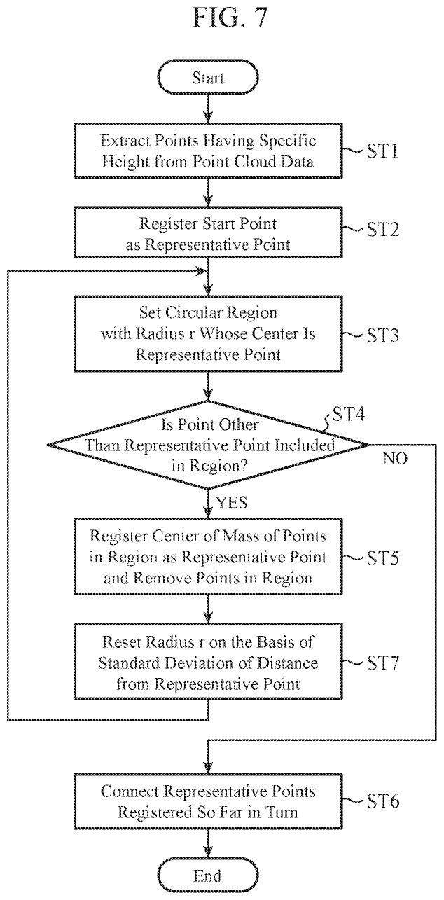

Next, an operation of the polyline drawing device of the third embodiment will be described using a flowchart of FIG. 7. In the flowchart of FIG. 7, processes at step ST1 to ST5 are the same as those of the first embodiment. When the process at step ST5 is performed, in the third embodiment, with respect to a point in a region, a standard deviation of a distance from the center of the region which is a representative point is calculated, and the radius r of the region is reset on the basis of the standard deviation (step ST7). For example, when the calculated standard deviation is σ, as for the radius r, r=2σ is set. Note that although here the radius of the region is set using the standard deviation, the configuration is not limited to the case of using the standard deviation, and other statistics may be used. Operation performed at and after step ST3 after resetting the radius r at step ST7 is the same as that of the first embodiment. By this, the radius r is reset every time calculation of a representative point based on a circular region is repeated.

In the above-described example, the range of a local region is reset. Alternatively, the shape of the local region may be changed. Further, both the range and shape of the local region may be changed.

As described above, according to the polyline drawing device of the third embodiment, when the vertex creating unit performs setting of the next one of the local regions using the one of the representative points as a reference, the vertex creating unit changes at least one of a value of a shape and a value of a range of the next one of the local regions every time a process of setting the next one of the local regions using the one of the representative points as the reference is performed. Thus, representative points can be more accurately obtained.

In addition, according to the polyline drawing device of the third embodiment, the vertex creating unit calculates distances from respective points included in the next one of the local regions to a center of the next one of the local regions, and determines the at least one of the value of the shape and the value of the range using statistics of the distances. Thus, the value to be changed can be accurately obtained.

### Fourth Embodiment

In a fourth embodiment, when a vertex creating unit 13 sets a local region using a representative point as a reference, the vertex creating unit 13 sets a next representative point after removing off-points included in the local region. The configurations of a polyline drawing device in figures are the same as those of FIGS. 1 and 2, and thus are described using these drawings.

The vertex creating unit 13 of the fourth embodiment is configured in such a manner that, in addition to the function of the vertex creating unit 13 of the first embodiment, when the vertex creating unit 13 obtains a point indicating a point cloud distribution state of a local region as a representative point, the vertex creating unit 13 sets a region in which off-points are removed as the local region. Other configurations are the same as those of the first embodiment, and thus, description thereof is omitted here.

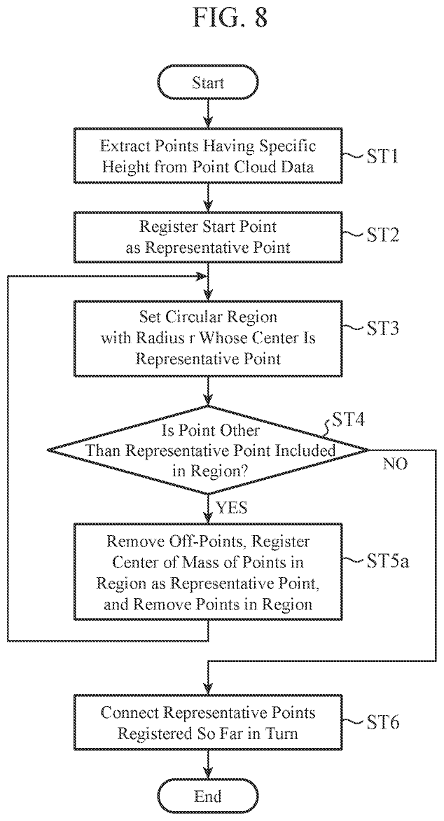

Next, an operation of the polyline drawing device of the fourth embodiment will be described using a flowchart of FIG. 8. In the flowchart of FIG. 8, processes at step ST1 to ST4 are the same as those of the first embodiment. In the fourth embodiment, when performing a process at step ST5a, the vertex creating unit 13 removes off-points, and then calculates a next representative point. The removal of off-points is performed as follows. For example, for each point in a circular region, the closest point is searched for in the region, and the distance to the closest point is calculated. Thereafter, an average of the distances to the closest points is calculated, and if there is a point whose distance to its closest point greatly differs from the average, then the point is determined to be an off-point and removed. In this determination, for example, the standard deviation is used, and when the average of distances to the closest points is d and the standard deviation is σ, a point whose distance to its closest point exceeds (d+2σ) is determined to be an off-point. Note that other than a method of removing off-points using statistics such as that described here, a method of removing off-points based on clustering may be used. For such a method, for example, a method shown in the document: Birant Derya, Alp Kut, “ST-DBSCAN: An algorithm for clustering spatial-temporal data”, Data & Knowledge Engineering, vol. 60, no. 1, pp. 208-221, 2007 can also be used.

At step ST5a, processes after removing off-points are the same as those of the first embodiment as follows: the center of mass of the points in the circular region is calculated, the center of mass is registered as a next representative point, and all points other than the next representative point that are included in the circular region are removed from the extracted point cloud. Furthermore, step ST6 is the same as that of the first embodiment.

As described above, according to the polyline drawing device of the fourth embodiment, when the vertex creating unit obtains the point indicating the distribution state of the point cloud in the one of the local regions as the one of the representative points, the vertex creating unit sets the one of the local regions after removing off-points included in the one of the local region. Thus, representative points can be more accurately obtained.

In addition, according to the polyline drawing device of the fourth embodiment, the vertex creating unit calculates a distance from each point in the one of the local regions to a closest point to each point in the one of the local regions, and determines a point whose distance to the closest point is greater than a threshold value to be an off-point. Thus, off-points can be accurately obtained.

Note that in the invention of the present application, a free combination of the embodiments, modifications to any component of the embodiments, or omissions of any component of the embodiments are possible within the scope of the invention.

### INDUSTRIAL APPLICABILITY

As described above, the polyline drawing device according to the invention relate to a configuration for obtaining a specific polyline from three-dimensional point cloud data, and are suitable, for example, for drawing a contour line from three-dimensional point cloud data obtained by measuring a three-dimensional shape such as a terrain.

### REFERENCE SIGNS LIST

10: Polyline drawing device, 11: Three-dimensional point cloud data reading unit, 12: Point cloud extracting unit, 13: Vertex creating unit, 14: Polyline output unit, 20: Parameter input device, 30: Display device.

1. A polyline drawing device comprising processing circuitry
to extract a target point cloud for drawing a polyline;
to perform processes including: setting one of local regions in the target point cloud; obtaining a point being located in a center of mass of points of a point cloud in the one of the local regions as one of representative points; removing points other than the one of the representative points included in the one of the local regions for which the point being located in the center of mass is obtained; setting a circular region whose center is the one of the representative points to next one of the local regions; and obtaining a point being located in a center of mass of points of a point cloud in the next one of the local regions as next one of the representative points; and
to draw a polyline by connecting all of the representative points obtained by the vertex creating unit in turn.

2. A polyline drawing device comprising processing circuitry
to extract a target point cloud for drawing a polyline;
to perform processes including: setting one of local regions in the target point cloud; obtaining a point indicating a distribution state of a point cloud in the one of the local regions as one of representative points; calculating a distances from points of a point cloud in the one of the local regions to a center of the one of the local regions; setting next one of the local regions using the one of the representative points as a reference with changing at least one of a value of the shape and a value of a range of the one of the local regions using statistics of the distances; and obtaining a point indicating a distribution state of a point cloud in the next one of the local regions as next one of the representative points; and
to draw a polyline by connecting all of the representative points obtained by the vertex creating unit in turn.

3. A polyline drawing device comprising processing circuitry
to extract a target point cloud for drawing a polyline;
to perform processes including: setting one of local regions in the target point cloud; calculating a distance from each point of a point cloud in the one of the local regions to a closest point in the one of the local regions; determining a point whose distance to the closest point is greater than a threshold value to be an off-point; obtaining a point indicating a distribution state of a point cloud obtained by removing the off-point from a point cloud in the one of the local regions as one of representative points; setting next one of the local regions using the one of the representative points as a reference;
to perform, for the next one of the local regions, processes including: calculating a distance from each point of a point cloud in the next one of the local regions to a closest point in the next one of the local regions; determining a point whose distance to the closest point is greater than a threshold value to be an off-point; and obtaining a point indicating a distribution state of a point cloud obtained by removing the off-point from a point cloud in the next one of the local regions as next one of the representative points; and
to draw a polyline by connecting all of the representative points obtained by the vertex creating unit in turn.

4. The polyline drawing device according to claim 1, wherein the vertex creating unit performs said obtaining the point as the next one of the representative points until the target point cloud has no more points that are not included in any of the next one of the local regions.

5. The polyline drawing device according to claim 1, wherein the point cloud extracting unit extracts a point cloud in a range in one-dimensional coordinate axis direction from a three-dimensional point cloud as the target point cloud.
